(19) United States
(12) Patent Application Publication
(10) Pub. No.: US 2012/0229365 A1
(43) Pub. Date: Sep. 13, 2012

(54) CONNECTOR APPARATUS WITH TRANSMITTING AND RECEIVING SIGNALS FUNCTION

(76) Inventor: Nai-Chien CHANG, New Taipei City (TW)

(21) Appl. No.: 13/351,208

(22) Filed: Jan. 16, 2012

(30) Foreign Application Priority Data
Mar. 11, 2011 (TW) 100204346

(51) Int. Cl. H01Q 1/50

(52) U.S. Cl. 343/906

(57) ABSTRACT

A connector apparatus with transmitting and receiving signals function includes a base body, an antenna structure, and a wireless transceiver module. The base body includes a platform. The platform includes a assembling part. The assembling part includes a plurality of conductive pins. The conductive pins are extended to the outside of the platform to be electrically connected to a mainboard of an electronic device. The base body includes a side pillar which is at one side of the platform and connected to the antenna structure. The wireless transceiver module inserts into the assembling part of the base body. The antenna structure is in the outside of a housing of the electronic device. The angle between the side pillar and the antenna structure is adjustable to receive or transmit wireless signals. Moreover, the antenna structure is folded into the housing if the antenna structure is not used.

### BACKGROUND OF THE INVENTION

1. Field of the Invention

The present invention relates to a connector apparatus, and especially relates to a connector apparatus with transmitting and receiving signals function.

2. Description of Prior Art

The volume of the wireless transceiver module nowadays is small, so that the wireless transceiver module is able to be arranged in the housing of the electronic device or combined with a mainboard easily. The electronic device with transmitting and receiving signals function would attract consumers to purchase.

Usually, the wireless transceiver module is inserted into the connector of the mainboard of the electronic device, so that the wireless transceiver module is electrically connected to the mainboard. A transmission wire is electrically connected between the mainboard and an antenna connector which is in the panel of the housing, and then the antenna connecter is connected to an antenna structure. Therefore, the electronic device is able to transmit and receive wireless signals.

Although the electronic device mentioned above is able to transmit and receive wireless signals, there are too many electronic components in the electronic device, and the assembly of the electronic device is complicated. Besides, the wireless signals would be distorted because of too many connection points.

### SUMMARY OF THE INVENTION

In order to solve the above-mentioned problems, an object of the present invention is to provide a connector apparatus with transmitting and receiving signals function.

In order to achieve the object of the present invention mentioned above, the connector apparatus of the present invention includes a base body, an antenna structure, and a wireless transceiver module. The base body includes a platform. The platform includes a assembling part. The assembling part is plural jacks or slots. The assembling part includes a plurality of conductive pins. The conductive pins are extended to the outside of the platform. The base body includes a side pillar which is at one side of the platform and is perpendicular to the platform. The side pillar includes a transmission wire. One side of the transmission wire is electrically connected to one of the conductive pins. The side pillar at least includes an interlocking part. The interlocking part includes an interlocking hole and a conductive part. The conductive part is on the edge of the interlocking hole and is electrically connected to the other side of the transmission wire. The antenna structure includes a transceiver body and a pivot part. The pivot part is on one side of the transceiver body. The pivot part includes at least a through hole. The through hole is arranged opposite to the interlocking hole. The antenna structure includes a pivot shaft which is through the through hole and the interlocking hole. The antenna structure is connected to the side pillar. The angle between the side pillar and the transceiver body is adjustable to receive or transmit wireless signals. The transceiver body is a metal single rod, or telescopically expandable/foldable multi-rods. The wireless transceiver module includes a printed circuit board and a wireless transceiver chip. The wireless transceiver chip is mounted on the printed circuit board. The wireless transceiver module includes plural conductive terminals which are at one side of the printed circuit board and are electrically connected to the wireless transceiver chip. The conductive terminals are plural acicular pins or golden fingers.

### BRIEF DESCRIPTION OF DRAWING

FIG. 1 shows a perspective view of the combination of the base body and the antenna structure.

FIG. 2 shows a perspective view of the combination of the base body, the antenna structure, and the wireless transceiver module.

FIG. 3 shows a drawing of the combination of the connector apparatus of the present invention and the mainboard of the electronic device.

FIG. 4 shows another drawing of the combination of the connector apparatus of the present invention and the mainboard of the electronic device (the transceiver body is parallel to the mainboard).

FIG. 5 shows a perspective view of the combination of the connector apparatus of the present invention and the electronic device.

FIG. 6 shows a perspective view of the combination of another embodiment of the base body and the antenna structure.

### DETAILED DESCRIPTION OF THE INVENTION

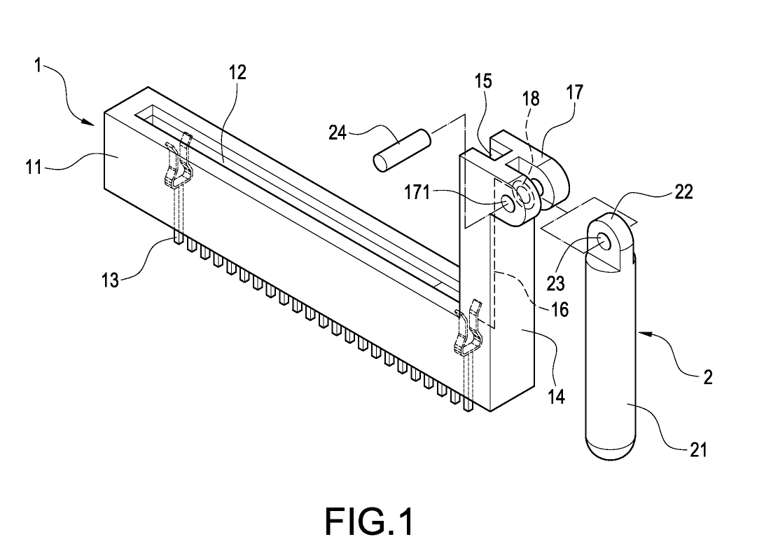

FIG. 1 shows a perspective view of the combination of the base body and the antenna structure. The connector apparatus with transmitting and receiving signals function of the present invention includes a base body 1 and an antenna structure 2.

The base body 1 includes a platform 11. The platform 11 includes a assembling part 12. The assembling part 12 is plural jacks or slots. The assembling part 12 includes a plurality of conductive pins 13. The conductive pins 13 are extended to the outside of the platform 11, so that the conductive pins 13 are able to insert into a mainboard of an electronic device (not shown in the Fig.) and are electrically connected to the mainboard.

The base body 1 includes a side pillar 14 which is at one side of the platform 11 and is perpendicular to the platform 11. The side pillar 14 includes a fillister 15 which is used to fix a wireless transceiver module (not shown in the Fig.). The side pillar 14 includes a transmission wire 16. One side of the transmission wire 16 is electrically connected to one of the conductive pins 13. Besides, the side pillar 14 includes at least an interlocking part 17. The interlocking part 17 includes an interlocking hole 171 and a conductive part 18. The conductive part 18 is on the edge of the interlocking hole 171 and is electrically connected to the other side of the transmission wire 16. The interlocking hole 171 is able to be pivotally connected to the antenna structure 2.

The antenna structure 2 includes a transceiver body 21 and a pivot part 22. The pivot part 22 is at one side of the transceiver body 21. The pivot part 22 includes at least a through hole 23. The through hole 23 is arranged opposite to the interlocking hole 171. The antenna structure 2 includes a pivot shaft 24 which is through the through hole 23 and the interlocking hole 171. The antenna structure 2 is connected to the side pillar 14. The angle between the side pillar 14 and the transceiver body 21 is adjustable to receive or transmit wireless signals. The transceiver body 21 is a metal single rod, or telescopically expandable/foldable multi-rods.

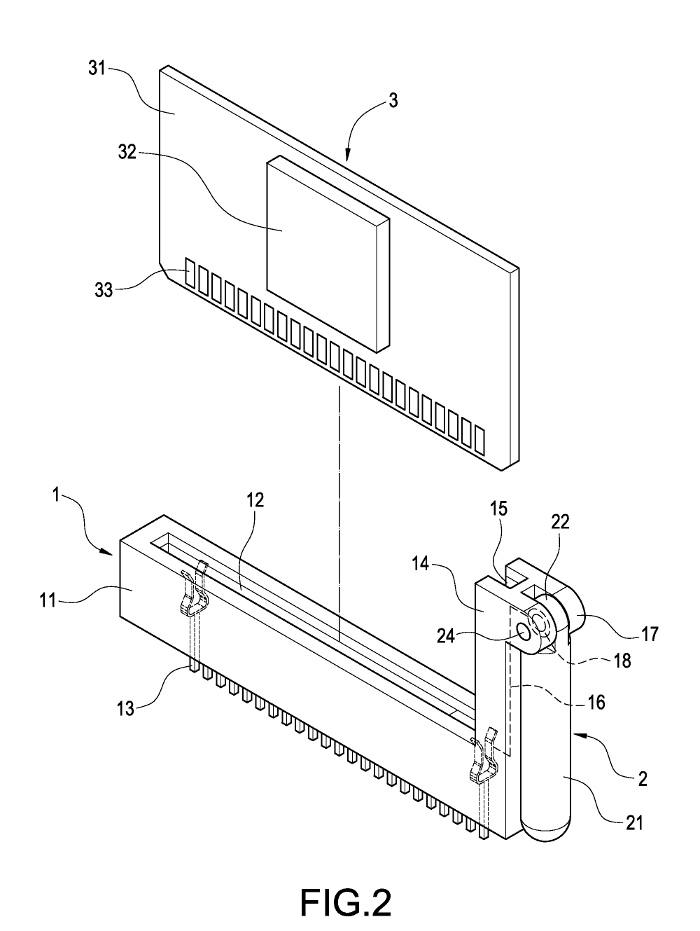

FIG. 2 shows a perspective view of the combination of the base body, the antenna structure, and the wireless transceiver module. The connector apparatus with transmitting and receiving signals function of the present invention further includes a wireless transceiver module 3. The wireless transceiver module 3 includes a printed circuit board 31 and a wireless transceiver chip 32. The wireless transceiver chip 32 is mounted on the printed circuit board 31. The wireless transceiver module 3 includes plural conductive terminals which are at one side of the printed circuit board 31 and are electrically connected to the wireless transceiver chip 32. The conductive terminals 33 are plural acicular pins or golden fingers.

The conductive terminals 33 are electrically connected to the conductive pins 13 after the printed circuit board 31 is slipped through the fillister 15 and into the assembling part 12. One of the conductive terminals 33 is electrically connected to the transmission wire 16 through one of the conductive pins 13.

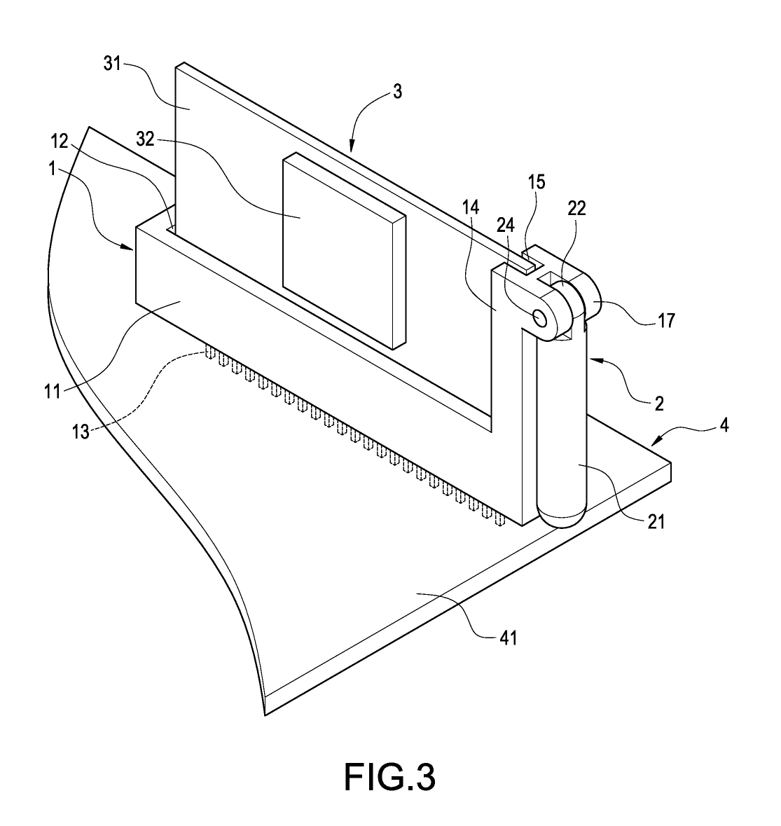

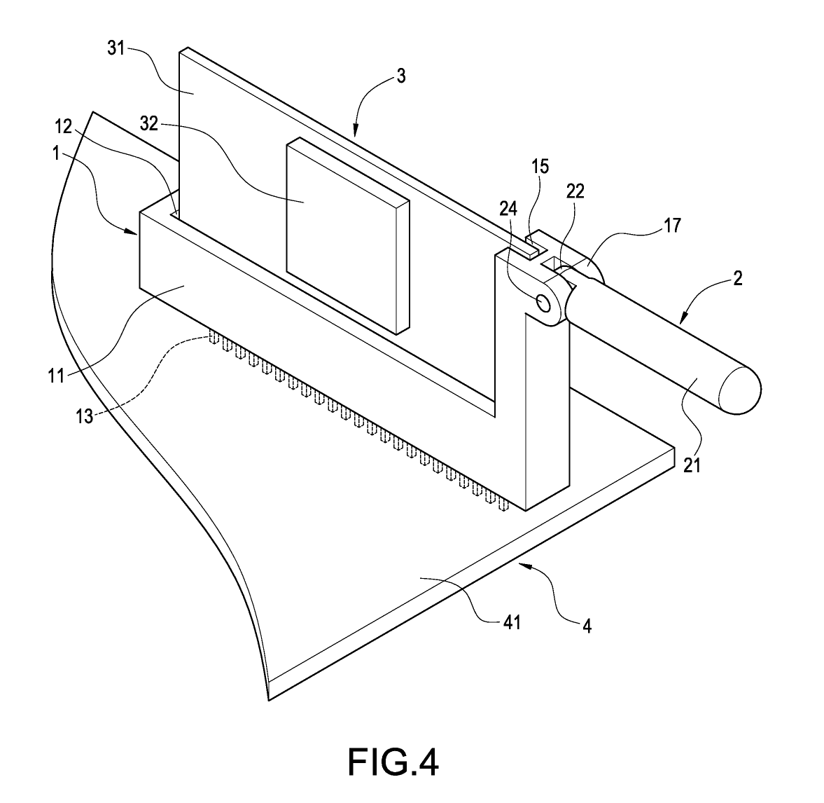

FIG. 3 shows a drawing of the combination of the connector apparatus of the present invention and the mainboard of the electronic device. FIG. 4 shows another drawing of the combination of the connector apparatus of the present invention and the mainboard of the electronic device (the transceiver body is parallel to the mainboard). The printed circuit board 31 of the wireless transceiver module 3 inserts into the base body 1 after the conductive pins 13 of the base body 1 are electrically connected to a mainboard 41 of an electronic device 4.

The wireless signals are processed by the wireless transceiver chip 32 after the wireless signals are received by the transceiver body 21 and through the conductive part 18, the transmission wire 16, one of the conductive pins 13, and one of the conductive terminals 33. Then the signals are sent through the conductive terminals 33 and the conductive pins 13 to the mainboard 41 of the electronic device 4 to be processed by the mainboard 41.

Similarly, the signals are processed by the wireless transceiver chip 32 after the signals are sent from the mainboard 41 to the wireless transceiver chip 32 through the conductive pins 13 and the conductive terminals 33. Then the signals are sent from the wireless transceiver chip 32 to the transceiver body 21 through one of the conductive terminals 33, one of the conductive pins 13, the transmission wire 16, and the conductive part 18. Finally, the signals are wireless transmitted out from the transceiver body 21.

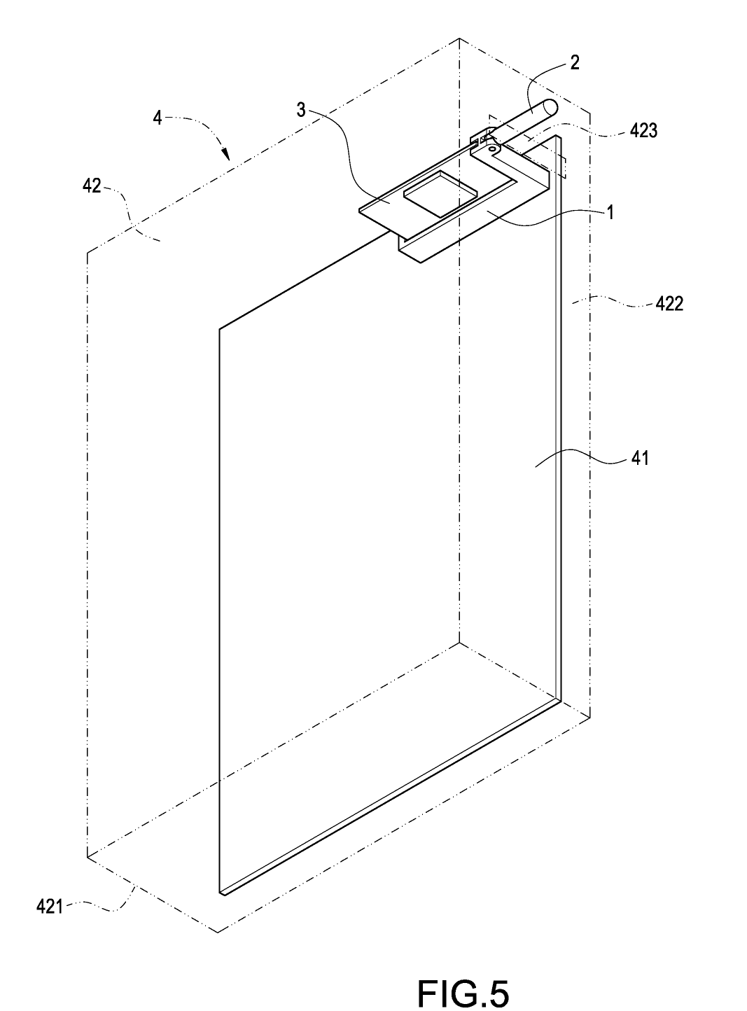

FIG. 5 shows a perspective view of the combination of the connector apparatus of the present invention and the electronic device. A front panel 421 (or a back panel 422) of a housing 42 of the electronic device 4 includes a vent 423. The vent 423 is opposite to the side pillar 14 of the base body 1, so that a part of the side pillar 14 and the antenna structure 2 are in the outside of the vent 423. The angle between the side pillar 14 and the transceiver body 21 is adjustable to receive or transmit wireless signals. If the transceiver body 21 is telescopically expandable/foldable multi-rods, there is enough space for the transceiver body 21 to be expanded/folded. The transceiver body 21 is folded and closed to the side pillar 14 if the transceiver body 21 is not used.

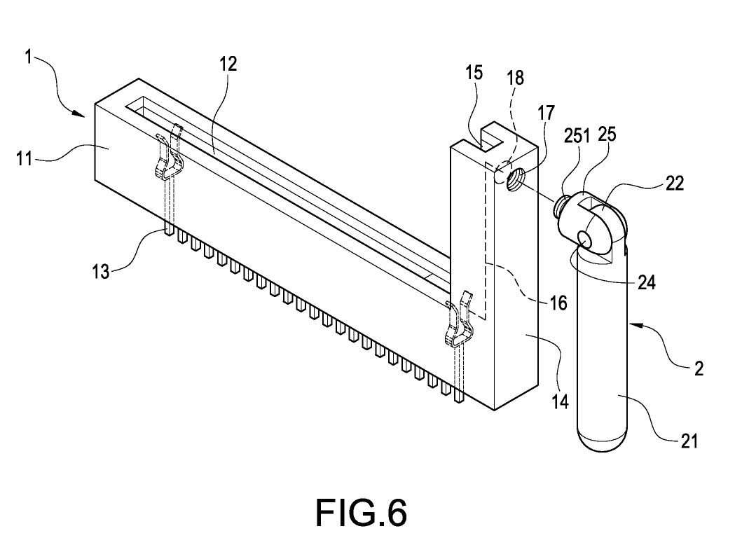

FIG. 6 shows a perspective view of the combination of another embodiment of the base body and the antenna structure. The interlocking part 17 is a screwed hole. The antenna structure 2 includes a joining part 25. The pivot part 22 is connected to the joining part 25. The joining part 25 includes a locking component 251. The locking component 251 is able to screw into the interlocking part 17. In the FIG. 6, the locking component 251 is a screwed shaft.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A connector apparatus with transmitting and receiving signals function, the connector apparatus being electrically connected to a mainboard of an electronic device, the connector apparatus including:
a base body, the base body including a platform, the platform including a assembling part, the assembling part including a plurality of conductive pins, the conductive pins being extended to the outside of the platform, the base body including a side pillar, the side pillar being at one side of the platform, the side pillar including a fillister, a transmission wire and an interlocking part, one side of the transmission wire being electrically connected to one of the conductive pins; and
an antenna structure, the antenna structure including a transceiver body and a pivot part, the pivot part being at one side of the transceiver body, the pivot part being connected to the interlocking part, the antenna structure being connected to the side pillar and electrically connected to the transmission wire.

2. The connector apparatus in claim 1, wherein the assembling part is plural jacks or slots.

3. The connector apparatus in claim 2, further including:
a wireless transceiver module connected to the assembling part.

4. The connector apparatus in claim 3, wherein the wireless transceiver module includes a printed circuit board and a wireless transceiver chip, and the wireless transceiver chip is mounted on the printed circuit board, wherein the wireless transceiver module includes plural conductive terminals which are at one side of the printed circuit board and are electrically connected to the wireless transceiver chip.

5. The connector apparatus in claim 4, wherein the conductive terminals are plural acicular pins or golden fingers.

6. The connector apparatus in claim 2, wherein the side pillar is perpendicular to the platform.

7. The connector apparatus in claim 6, wherein the interlocking part includes an interlocking hole and a conductive part, and the conductive part is on the edge of the interlocking hole and is electrically connected to the other side of the transmission wire.

8. The connector apparatus in claim 7, wherein the pivot part includes at least a through hole, and the through hole is arranged opposite to the interlocking hole, wherein the antenna structure further includes a pivot shaft which is through the through hole and the interlocking hole, so that the antenna structure is connected to the pivot part and is electrically connected to the conductive part.

9. The connector apparatus in claim 1, wherein the interlocking part is a screwed hole.

10. The connector apparatus in claim 9, wherein the antenna structure further includes a joining part, and the pivot part is connected to the joining part, wherein the joining part includes a locking component which is able to screw into the interlocking part.

11. The connector apparatus in claim 10, wherein the locking component is a screwed shaft.

12. The connector apparatus in claim 1, wherein the transceiver body is a metal single rod, or telescopically expandable/foldable multi-rods.
